(19) United States
(12) Patent Application Publication
(10) Pub. No.: US 2005/0105943 A1
(43) Pub. Date: May 19, 2005

(54) Multifunction product

(76) Inventors: Sang-cheol Park, Suwon-si (KR); Young-min Kim, Suwon-si (KR); Byung-sun Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/802,798

(22) Filed: Mar. 18, 2004

(30) Foreign Application Priority Data
Nov. 14, 2003 (KR) 2003-80685

(51) Int. Cl. G03G 15/00

(52) U.S. Cl. 399/405

(57) ABSTRACT

A multifunction product comprising a main machine, a flat bed for mounting a document on an upper part, a flat bed cover with one end being hinge-joined to the main machine, to open and close the flat bed, a scanner for scanning a document set on the flat bed, and converting an optical signal obtained from the scanning into an electrical signal, a printing unit closely installed on the lower part of the scanner, a paper feeder for supplying a paper to the printing unit, and a discharged paper tray installed on one side of the main machine and formed at a predetermined sloping angle with respect to the mounting direction, to receive in the paper delivering direction. The discharged paper tray is formed to receive a discharged paper so as to prevent possible damage to the paper which is usually weakened by the high temperature and high pressure of the printing unit.

### PRIORITY

This application claims benefit under 35 U.S.C. § 119 from Korean Patent Application No. 2003-80685, filed on Nov. 14, 2003, the entire contents of which are incorporated herein by reference.

### BACKGROUND OF THE INVENTION

1. Field of the Invention

The present invention relates to an image forming apparatus, and more particularly to a multifunction product performing functions of a printer, a scanner, a facsimile, and a copying machine.

2. Description of the Related Art

The multifunction product (MFP) generally refers to an office apparatus which performs multiple office-related functions. For example, an MFP can provide a printer function for printing input data, and a facsimile function for scanning a document, as well as build image data, and transmit the image data to another place through a communication line. The multifunction product generally includes a scanner for scanning a document and a printing unit for printing a document, so as to be generally used as a scanner, a printer, or a copying machine according to the selection by a user.

FIG. 1 shows one example of the multifunction product. As shown in FIG. 1, the general electrophotographic multifunction product 1 includes a paper feeder 10, a paper delivering part 20, an image developing unit 30, a fuser 40, a paper discharging unit 50, a discharged paper tray 60, and a scanner 70. A flat bed 71 is formed on the upper side of the scanner 70 to set a document, which is an object to be scanned, and a flat cover 72 is hinge-joined to one end of the upper side of the multifunction product 1 to open and close the flat bed 71. When the multifunction product 1 operates as a printer or a copying machine, an image input from the flat bed 71 or an external device goes through the same process as the conventional electrophotographic image forming apparatus. Accordingly, a paper fed from the paper feeder 10 is delivered from the paper delivering part 20 having a plurality of rollers, to the developing unit 30 and a toner image is formed on a surface of the paper. The fuser 40 then fixes the toner image on the paper with high temperature and pressure, and the paper is received in the discharged paper tray 60 through the paper discharging unit 50, which consists of a plurality of paper discharging rollers.

As described above, the paper is kept under high temperature and high pressure during the image fixing by the fuser 40, and is delivered to the paper discharging unit 50. Because the paper has been kept under high temperature, the paper is apt to be deformed by external pressure, and if the paper discharging unit 50 forms a rapid curve as shown in FIG. 1, it is very likely to get the paper jammed or crumpled at that point. Also, since the discharged paper tray 60 is positioned on the lower side of the scanner 70, the height of the multifunction product has to be increased as much as the distance between the discharged paper tray 60 and the scanner 70. There is another problem in that if the paper is jammed at the paper discharging unit 50, it is difficult to remove the jammed paper because the paper discharging unit 50 is installed at a position which is hard for a user to access.

### SUMMARY OF THE INVENTION

The present invention has been developed in order to solve the above drawbacks and other problems associated with the conventional arrangement of a multifunction product. One aspect of an embodiment of the present invention is to provide a multifunction product of improved structure, which achieves compactness of the product by reducing the height of the product and also enables easier paper removal when the paper is jammed.

Another aspect of an embodiment of the present invention is to provide a multifunction product which is configured in such a way that an output paper can be received lengthwise in a paper tray formed on the multifunction product main machine. The printed side of the paper is faced with the front side of the multifunction product main machine, so that a user can check the printing more easily.

The foregoing and other objects and advantages are substantially realized by providing a multifunction product, which comprises a main machine, a flat bed for mounting a document on its upper part, a flat bed cover whose one end is hinge-joined to the main machine of the multifunction product, for opening and closing the flat bed, and a scanner for scanning a document set to the flat bed, and converting an optical signal into an electrical signal. The multifunction product further comprises a printing unit closely installed on the lower part of the scanner, a paper feeder for supplying a paper to the printing unit, and a discharged paper tray installed on one side of the multifunction product main machine and formed at a predetermined sloping angle with respect to the mounting direction, for receiving in the paper delivering direction a paper that has been weakened by high temperature and high pressure while passing through the printing unit.

According to an embodiment of the present invention, an electrophotographic image forming apparatus is adopted as the printing unit. However, it should be appreciated that other printing apparatuses, such as an inkjet printer, can also be adequately used as the printing unit.

The inclination angle of the backside wall of the discharged paper tray has a value between 45°˜85° with respect to the horizontal position. If the inclination angle exceeds 85°, the received paper may fall down, whereas if the inclination angle is less than 45°, the length of the multifunction product main machine is excessively increased to the extent that it causes user inconvenience.

The discharged paper tray can be integrally formed with the multifunction product main machine to form a part of the outline of the multifunction product. The backside wall of the discharged paper tray facing the front end of the paper to be printed, is extended upward to support the paper that is received lengthwise.

In a preferred embodiment of the present invention, a door can be provided so that a user can access the paper discharging unit more easily if a paper jam occurs at the paper discharging unit of the multifunction product. The door can be hinge-joined to a sidewall on one side of the discharged paper tray, opposite to the front end of the paper being output. The door can be rotated to an open position by its own weight.

### BRIEF DESCRIPTION OF THE DRAWINGS

The above aspects and features of the present invention will be more apparent by describing certain embodiments of the present invention with reference to the accompanying drawings, in which:

FIG. 1 is a schematic, cross-sectional view of a multifunction product according to the conventional art;

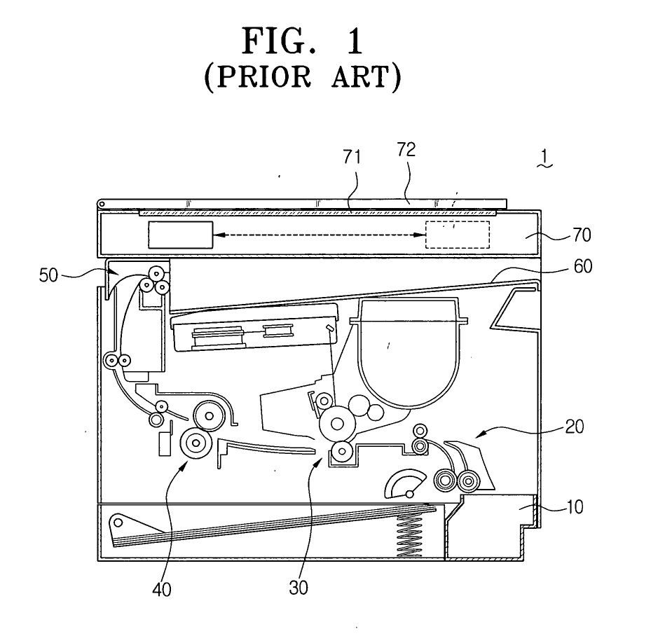

FIG. 2 is a perspective view of a multifunction product according to an embodiment of the present invention; and

FIG. 3 is a schematic, cross-sectional view of a multifunction product according to an embodiment of the present invention.

### DETAILED DESCRIPTION OF THE PREFERRED EMBODIMENTS

Certain embodiments of the present invention will be described in greater detail with reference to the accompanying drawings.

In the following description, the same drawing reference numerals are used for the same elements even in different drawings. The matters following description of the detailed construction and elements of the embodiments of the present invention are illustrative to assist in a comprehensive understanding of the invention. It is to be understood that the present invention can be carried out differently from the illustrated embodiments and be within the scope of the present invention as defined in the appended claims. Also, well-known functions or constructions are not described in detail for reasons of conciseness.

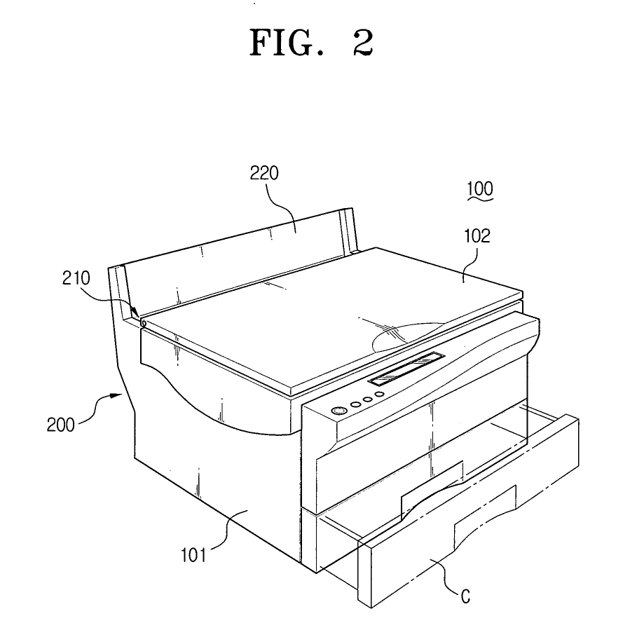

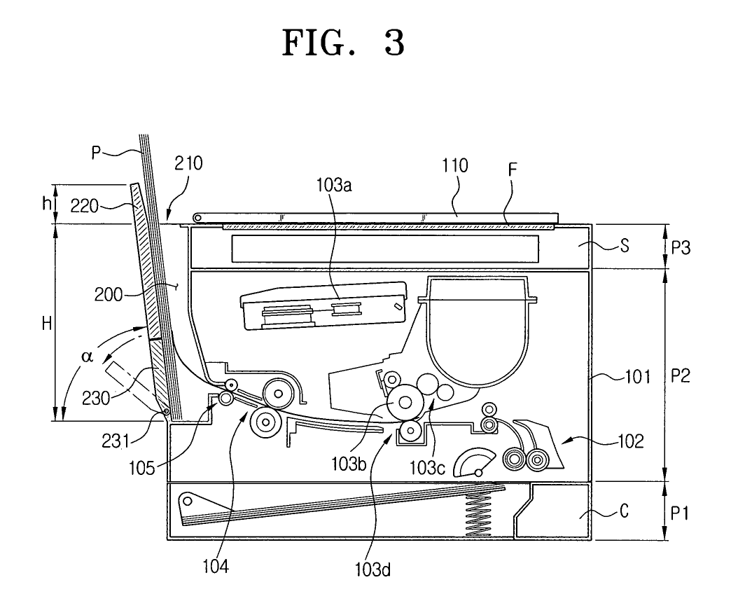

FIG. 2 is a perspective view showing a multifunction product according to a certain embodiment of the present invention, in which a multifunction product main machine (main machine) 101 is formed such that a paper feeder C, holding sheets of paper, is open to the front direction. A flat bed cover 102 is hinge-joined to the upper part of the main machine 101 to open and close a flat bed F (shown in FIG. 3) on which a document is set.

In the multifunction product 100 as shown in FIG. 3, according to one embodiment of the present invention, if the paper feeder C is installed in a first position P1, a printing unit in a second position P2, and a scanner S in a third position P3, it is possible to reduce the overall height of the multifunction product 100 because the parts in the second and the third positions P2 and P3 are installed without having a separate space therebetween.

A discharged paper tray 200 is installed on the back of the main machine 101, to receive a printed paper P. The discharged paper tray 200 comprises an open surface 210 with an open upper surface through which the printed paper P passes, and a backside wall 220 projected and extended in a predetermined height, to support the printed paper P. The discharged paper tray 200 can be integrally formed with the main machine 101 to form a part of the main machine 101. If the paper feeder C for receiving a paper P is installed in a first position P1, a printing unit for printing the paper P in a second position P2, and a scanner S in a third position P3, it is preferable that the discharged paper tray 200 be installed in the main machine 101 so as to be included as a part of either the second position P2 or the third position P3.

The backside wall 220 is set to a predetermined inclination angle α to prevent the printed paper P from falling down to the front side of the multifunction product 100. The inclination angle α can have a value between at or about 45° and at or about 85°. If the inclination angle α is less than about 45°, the length of the multifunction product 100 can be excessively lengthened and use too much space. Alternatively, the inclination angle α is more than 85°, the height of the multifunction product 100 is excessively increased and the volume of the product is increased.

The backside wall 220 can be projected a predetermined height h to the upper side of the multifunction product 100. The height h can be formed such that the sum of the height h and the whole depth H of the discharged paper tray 200 does not exceed 80% of the length of the paper P that has been printed and received in the paper tray 200. For example, A4 paper typically has a length of in the lengthwise direction of about 297 mm and the depth H of the backside wall is 220 mm, then the height h of the projecting part of the backside wall 220 can have a value of approximately 38 mm.

Furthermore, a door 230 can be installed on the backside wall 220, to be opened and closed according to selection by a user. The door 230 is installed such that a lower part of the discharged paper tray 200 is exposed to the outside. Accordingly, a user can access more easily to a paper discharging unit 105 if a paper jam occurs. The door 230 can be installed on the backside wall 220, by being hinge-joined to the backside wall 220. The door 230 then opens to the outside of the multifunction product 100. A hinge rotation axis 231 to which the door 230 is hinge-joined, can be installed on the lower side of the door 230 so that the door 230 can be opened by its own weight as the locking is released.

The operation of the multifunction product 100 according to the preferred embodiment of the present invention will now be described with reference to the accompanying FIG. 3.

The multifunction product 100 according to an embodiment of the present invention can be applied to a copying machine or a printer according to a selection by a user. If the multifunction product 100 is used for a copying machine, an original document to be copied is set on the flat bed F, and the scanner S delivers an image of the document to a printing controlling part (not shown) through a predetermined operation process. The image delivered to the printing controlling part is then converted into image information and passes through a predetermined output process. In one embodiment of the present invention, an electrophotographic image forming apparatus is used as a printing unit for performing the output process. The printing unit comprises an optical scanning device 103a, an image bearing body 103b, a developing unit 103c, a transferring unit 103d, a fuser 104, and a paper discharging unit 105. As the printing start command is received, the printing controlling part outputs a printing signal to the optical scanner 103a to form an electrostatic latent image on the surface of the image bearing body 103b, and the electrostatic image is converted into a visual image by means of the developing unit 103c. The paper P received in the paper feeder C is delivered to a transferring unit 103d through a paper delivering part 102 so that a toner image is formed on the surface of the paper P. The paper P on which the toner image is formed in this manner is heated and compressed with high temperature and high pressure by the fuser 104 so that the toner image is fixed. The paper P is then discharged to the discharged paper tray 200 through the paper discharging unit 105 consisting of a plurality of rollers.

Although the paper P is delivered to the developing unit 103c along a U-shaped delivering path from the paper delivering part 102, the delivering path after the fuser 104 is formed with a smooth curve, so that deformation or damage to the paper P due to heat and pressure is substantially prevented. After the paper P is passed through the paper discharging unit 105, which consists of a pair of paper discharging rollers, the paper P is discharged to the outside of the main machine 101. After that, the paper P contacts the backside wall 220, bending in a smooth curve, and is received lengthwise, sheet by sheet, in the discharged paper tray 200 as shown in FIG. 3. It is preferable that the printed surface of the paper P faces the front side of the multifunction product 100 so that a user can check the printed results immediately.

If the paper P is jammed at the paper discharging unit 105, a user can remove the jammed paper P by opening the door 230. To remove the jammed paper P, the user releases the locking device on the door 230, and as the door 230 is rotated around a hinge rotation axis 231 by its own weight to a full opening degree, the user accesses the paper discharging unit 105 and removes the jammed paper P.

With the multifunction product according to the embodiments of the present invention as set forth above, the discharged paper tray is installed on one side of the multifunction product main machine so that printed paper can be received lengthwise, and the height of the multifunction product can be reduced. As a result, compactness of the product can be achieved. Furthermore, it is possible to remove jammed paper more conveniently, by installing an easily opened door on the backside wall of the discharged paper tray, and improving user accessibility to the paper discharging unit where most of paper jamming occurs.

The foregoing embodiments and advantages are merely exemplary and are not to be construed as limiting the present invention. The present teaching can be readily applied to other types of apparatuses. Also, the description of the embodiments of the present invention are intended to be illustrative, and not to limit the scope of the claims, and many alternatives, modifications, and variations will be apparent to those skilled in the art.

1. A multifunction product (MFP) for use as at least two among a scanner, a copying machine, a printer, and a facsimile, according to a selection by a user, the MFP comprising:
a main machine;
a flat bed for mounting a document on an upper part;
a flat bed cover with one end being hinge-joined to the main machine, the flat bed cover for opening and closing the flat bed;
a scanner for scanning a document set on the flat bed, and converting an optical signal obtained from the scanning into an electrical signal;
a printing unit closely installed on a lower part of the scanner;
a paper feeder for supplying a paper to the printing unit; and
a discharged paper tray installed integrally with the main machine on one side of the main machine, for forming a part of an outline of the multifunction product, the discharged paper tray being formed at a predetermined sloping angle to receive in a paper delivering direction a paper that has been printed at the printing unit.

2. The MFP according to claim 1, wherein the discharged paper tray is projected on one side of the main machine to prevent interference to a conveyance along a delivering path of the scanner, with a backside wall facing a front end of a paper to be printed, and is extended upward higher than the scanner to support a received paper.

3. The MFP according to claim 2, wherein the discharged paper tray is configured such that an inclination angle of the backside wall has a value from at or about 45° to at or about 85° with respect to a horizontal position.

4. The MFP according to claim 1, wherein the discharged paper tray is configured such that an inclination angle of the backside wall has a value from at or about 45° to at or about 85° with respect to a horizontal position.

5. The MFP according to claim 1, wherein the printing unit comprises:
an optical scanner;
an image bearing body for forming an electrostatic latent image on a surface with a light generated from the optical scanner;
a developing unit for forming a visual image by supplying a toner to the image bearing body;
a transferring unit for transferring the visual image to a paper provided from the paper feeder;
a fuser for applying high temperature and high pressure onto the paper; and
a paper discharging unit for discharging the paper outside of the main machine.

6. The MFP according to claim 5, wherein a delivering path between the paper feeder and the fuser is formed in, or substantially formed in, a U shape.

7. The MFP according to claim 1, wherein the discharged paper tray comprises:
a door installed on a backside wall, for being opened and closed for the removal of a jammed paper.

8. The MFP according to claim 7, wherein the door is hinge-joined to the backside wall to be rotated to an open position by its own weight upon an opening operation.

9. A multifunction product (MFP) having a first position including a paper feeder to hold a paper for printing, a second position in which a printing unit is installed to receive the paper and form a visual image on the received paper, and a third position in which a flat bed is installed as a document mounting means and a scanner including a reading-out means is also installed, the MFP comprising:
a discharged paper tray for forming a part of either the second position or the third position.

10. The MFP according to claim 9, wherein the discharged paper tray is projected to one side of the MFP so as to form a part of an outer cover of the MFP.

11. The MFP according to claim 9, wherein the discharged paper tray is configured such that a backside wall of the discharged paper tray contacting a front end of a discharged paper from the printing unit is extended to exceed a height of the third position where the scanner is installed, to prevent an interference with the paper discharged from the printing unit along a delivering path of the scanner.
